(19) United States
(12) Patent Application Publication
(10) Pub. No.: US 2004/0268098 A1
(43) Pub. Date: Dec. 30, 2004

(54) Exploiting parallelism across VLIW traces

(76) Inventors: Yoav Almog, Haifa (IL); Ari Schmorak, Haifa (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/611,111

(22) Filed: Jun. 30, 2003

(51) Int. Cl. G06F 9/30

(52) U.S. Cl. 712/227; 712/216; 712/214

(57) ABSTRACT

A method and apparatus for improving instruction level parallelism across VLIW traces. Traces are statically grouped into VLIWs and dependency timing data is determined. VLIW traces are compared dynamically to determine data dependencies between consecutive traces. The dynamic comparison of dependency data determines the timing of execution for subsequent traces to maximize parallel execution of consecutive traces.

### BACKGROUND

1. Field of the Invention

The embodiments of the invention relate to computer systems. Specifically, the embodiments of the invention relate to improved parallelism in processing computer instructions.

2. Background

A central processing unit (CPU) of a computer system typically includes an execution core for processing instructions. Instructions are retrieved from a memory or storage device to be processed by an execution core. The sequential processing of instructions as they are retrieved from memory is a slow and inefficient process. Processing instructions in parallel increases the processing-speed and efficiency of the computer system. A CPU may include multiple execution cores in order to facilitate the parallel processing of instructions and improve the speed and efficiency of executing the instructions.

One method of improving the speed of processing instructions is to process the instructions out of order (OOO). However, this method of processing instructions requires significant overhead to track the relative order of the instructions and to schedule the execution of the instructions. Consequently, OOO processing is not efficient in terms of power consumption and space consumption. OOO processing may be used in combination with speculative processing. Instructions often contain conditional branching instructions that determine the path that execution will follow through a set of instructions. A CPU may speculate as to the path that will be taken when retrieving a set of instructions that includes branch instructions. This allows the CPU to retrieve the instructions of the predicted path in advance of their execution. Retrieving instructions in advance of execution improves the speed of processing because the CPU will not have to wait for the slow retrieval of instructions from memory at the time a conditional branch is resolved. However, the CPU may incorrectly speculate as to how the branch will be resolved forcing the CPU to discard the retrieved instructions and retrieve a new set of instructions. This results in inefficient use of processing resources to manage the discard of unneeded instructions and retrieval of needed instructions.

### BRIEF DESCRIPTION OF THE DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a diagram of a computer system.

FIG. 2 is a diagram of the internal components of a processor.

FIG. 3 is a flowchart for the execution of an arbitration unit.

FIG. 4 is a flowchart for the execution of a VLIW trace compiler.

FIG. 5A is a tabular illustration of a set of traces.

FIG. 5B is a tabular illustration of a set of VLIWs derived from a set of traces.

FIG. 5C is a tabular illustration of the execution of a set of traces.

### DETAILED DESCRIPTION

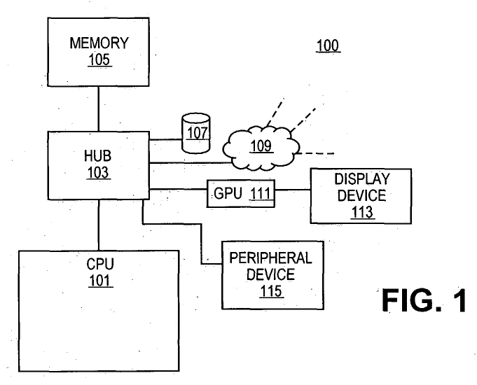

FIG. 1 is a diagram of a computer system 100. Computer system 100 includes a central processing unit (CPU) 101. CPU 101 is connected to a communications hub 103. Communications hub 103 controls communication between the components of computer system 100. In one embodiment, communications hub 103 is a single component. In another embodiment, communications hub 103 includes multiple components such as a north bridge and south bridge. Communications hub 103 handles communication between system memory 105 and CPU 101. System memory 105 stores program instructions to be executed by CPU 101. Communications hub 103 also allows CPU 101 to communicate with fixed and removable storage devices 107, network devices 109, graphics processors 111, display devices 113 and other peripheral devices 115. Computer system 100 may be a desktop computer, server, mainframe computer or similar machine.

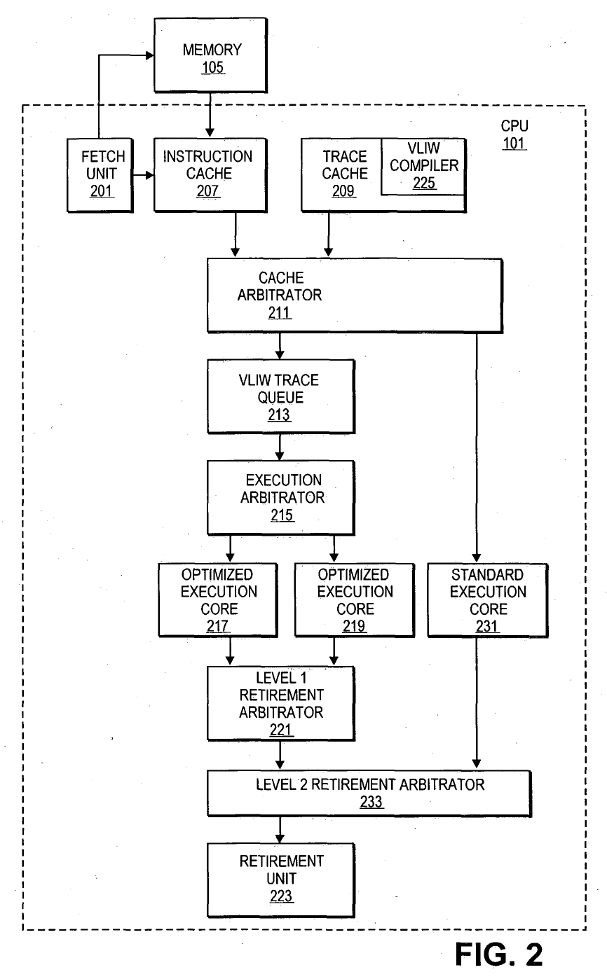

FIG. 2 is an illustration of the internal components of CPU 101. In one embodiment, CPU 101 is coupled to system memory 105. CPU 101 may be coupled indirectly with system memory 105 through a communications hub 103 as illustrated in FIG. 1. System memory 105 stores instructions to be executed by execution cores 217, 219 and 231 in CPU 101.

In one embodiment, CPU 101 includes multiple execution cores 217, 219 and 231. Execution cores 217, 219 and 231 may have multiple execution units to process instructions. Optimized execution cores 217, 219 may be dedicated to executing a discrete category of program code or similar grouping of instructions. Execution cores 217, 219 may process frequently used instructions or a similar category of instructions while less frequently used instructions are processed by standard execution core 233 in CPU 101. In one embodiment, standard execution cores 233 may use standard out of order processing architecture or similar architectures.

In one embodiment, fetch unit 201 generates memory access requests to system memory 105 to retrieve the instructions to be executed by execution cores 217, 219 and 231. Instructions retrieved from system memory 105 may be stored in instruction cache 207. Fetch unit 201 may check instruction cache 207 and trace cache 209 to determine if instructions needed by execution cores 217, 219 and 231 are located there in order to avoid having to retrieve the needed instructions from system memory 105. Instruction cache 207 stores instructions that have been recently retrieved from system memory 105 and instructions that have been recently used by execution cores 217, 219 and 231. Instruction cache 207 utilizes conventional cache management schemes such as least recently used (LRU) and similar schemes to maintain the most frequently used instructions in the instruction cache. This improves CPU 101 performance by obviating the need to retrieve instructions from system memory 105, which requires significant additional time due to the relative distance and complexity of the system memory 105 in comparison to instruction cache 207.

In one embodiment, CPU 101 includes a trace cache 209. Trace cache stores traces that have been recently used by execution cores 217 and 219. A trace is a sequence of instructions that reflects the dynamic execution of a program. The instructions of a program to be processed by CPU 101 may include branch instructions. These branch instructions create multiple ‘paths’ through the code of the program that may be followed in executing the program. The dynamic execution of the program is the actual path of instructions taken through the code of a program. Traces may be delineated by a specific set of criteria such as the placement of branching instructions in a trace or similar criteria. In one embodiment, traces are constructed such that branching instructions are positioned at the end of each trace, thereby defining the end points by the occurrence of a branching instruction and the start points by the instruction that follows the branching instruction. In one embodiment, traces are generated by tracking sequences of instructions that have been processed by the standard execution core 231.

In one embodiment, trace cache 209 is coupled to a very long instruction word (VLIW) compiler 225. VLIW compiler 225 analyzes traces stored in trace cache 209 to divide each trace into a set of VLIWs. A VLIW is a set of instructions that can be statically grouped together having data dependencies that do not rely upon the other instructions in the VLIW such that when executed the instructions in the VLIW can be executed in parallel by a single execution core.

In one embodiment, trace cache 209 and instruction cache 207 are coupled to a cache arbitrator 211. In one embodiment, cache arbitrator 211 determines the source for the next set of instructions or trace to be executed by execution cores 217, 219 and 231. Cache arbitrator 211 checks both trace cache 209 and instruction cache 207 to determine if an instruction is located in each. If the instruction is located in the trace cache 209 then the appropriate trace is forwarded to the VLIW trace queue 213 as a set of VLIWs. If the instruction is located only in the instruction cache 207 then the instruction is forwarded to the standard execution core 231 for processing. In one embodiment, a queue, buffer or similar device stores instructions to be processed by the standard execution core 231.

In one embodiment, VLIW trace queue 213 stores the VLIWs of a trace in program order. VLIW trace queue 213 may be a first in first out (FIFO) buffer or similar device. VLIW trace queue 213 is connected to execution arbitrator 215, which retrieves the traces of VLIWs stored in VLIW trace queue 213 in program order to be executed by one of the execution cores 217, 219.

In one embodiment, execution arbitrator 215 determines execution cores 217, 219 availability and assigns the next trace in program order to an available execution core 217, 219. Execution arbitrator 215 assigns traces to an optimized execution core based on the number of optimized execution cores 217, 219 available to process the trace and based upon the delay required to resolve data dependencies of the trace to be assigned.

In one embodiment, execution cores 217, 219 each contain all the resources and capabilities to execute any set of instructions assigned to each execution core 217, 219 and 231 such as floating point units, registers and similar devices. Each execution core may operate independent of the other execution cores to enable parallel processing of instructions assigned to each execution cores. Each execution core 217, 219 and 231 may forward or make available the results of the processing of instructions assigned to that execution core 217, 219 and 231 to first level retirement arbitrator 221 or second level retirement arbitrator 233.

In one embodiment, first level retirement arbitrator 221 retrieves data processed by optimized execution cores 217 and 219 in program order to be forwarded to the second level retirement arbitrator 233. Second level retirement arbitrator 233 receives data processed by standard execution core 231 and data from first level retirement arbitrator 221 to forward in program order to retirement unit 223. First level retirement arbitrator 221 may retrieve the first trace or set of instructions assigned to an optimized execution core after it has been processed and forward this data to second level retirement arbitrator 233. Thereafter first level retirement arbitrator 221 may alternate between optimized execution cores 217, 219 in retrieving processed data to forward to second level retirement arbitrator 233. Second level retirement arbitrator receives data in relative program order from first level retirement arbitrator 221 and standard execution core 231 and determines the overall program order of the data. This data is then forwarded in overall program order to retirement unit 223. In one embodiment, instructions or ‘switch points’ may be marked or tracked to facilitate the reordering process of the second level retirement arbitrator 233. A ‘switch point’ is the point in a set of traces or sequences of instructions when the next sequence or trace is sent to a different execution core from the previous sequence or trace.

In one embodiment, retirement unit 223 receives processed data and implements this data in the architecture of CPU 101 and computer system 100. Implementing the instructions may include updating values in registers of CPU 101, generating memory read or write operations to system memory 105, generating similar signals to components of computer system 100 and similar operations. The implementation of the results of the instructions is done in the program order of the instructions. The program order is maintained by the cache arbitrator 211, execution arbitrator 215 and retirement arbitrators 221, 233 in a manner that is transparent to the other components of CPU 101. This allows the components of CPU 101 to have relatively simple architectures because the amount of overhead data that must be maintained is greatly reduced in comparison with out of order processing architectures. This architectural simplicity results in improved power savings and reduced space requirements for CPU 101.

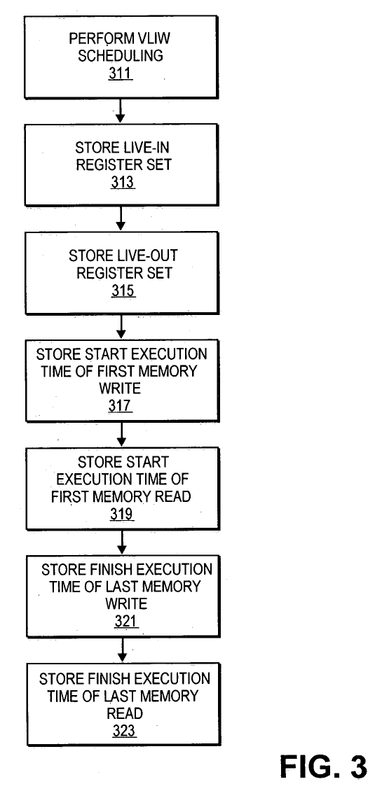

FIG. 3 is a flowchart illustrating the operation of VLIW compiler 225. VLIW compiler 225 is responsible for collecting and organizing a trace into a set of VLIW words that can be processed by optimized execution cores 217, 219. In one embodiment, VLIW compiler 225 analyzes a trace to identify the instructions therein that can be executed in parallel based on the resources required by each instruction (block 311). In one embodiment, VLIW scheduling is specialized to the target architecture such as the dual execution cores 217, 219 on trace queue 213. The scheduler attempts to place the maximum number of instructions into a single VLIW based on the available resources and execution times given a target architecture. Each VLIW is constructed to be independently executed from the other VLIWs. After determining the scheduling of the instructions in VLIWS, compiler 225 may generate and store a list of registers utilized by each VLIW or set of VLIWs in a trace. The list may be divided into live-in registers (block 313) and live-out registers (block 315). The lists of live-in registers and live-out registers may also track a set of data related to each register including a start of operation value, that represents the time at which an instruction that alters a register value begins in relation to the start of the trace and a finish of operation time value that represents the time at which an instruction completes.

In addition, compiler 225 may generate a set of data that tracks memory access instructions in each VLIW or trace. Compiler 225 may determine and store the start execution time, relative to the start of a trace or VLIW, of the first memory write in a VLIW or trace (block 317) and the first memory read (block 319) as well as the end execution time of the last memory write (block 321) and last memory read (block 323). This data is statically generated upon entry of a trace in trace cache 209 and can be used by execution arbitrator 215 to dynamically determine the data dependency timing between two traces.

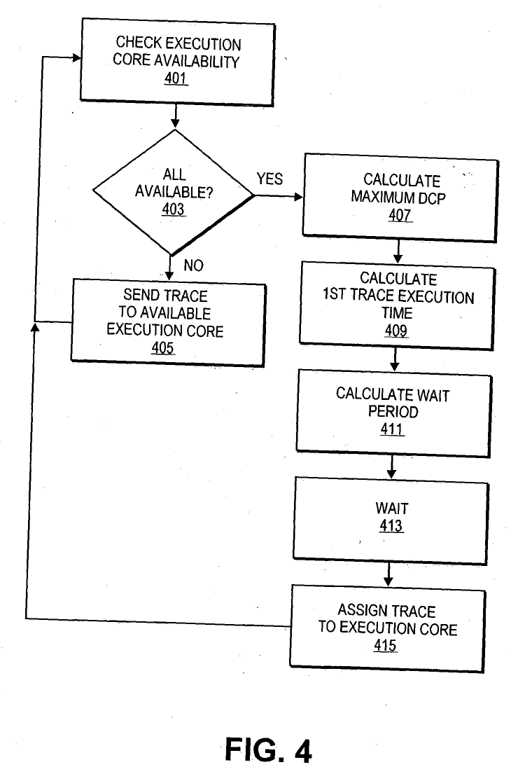

FIG. 4 is a flowchart of the operation of the execution arbitrator 215. In one embodiment, when a trace is present in the VLIW trace queue 213, execution arbitrator 215 determines the availability of each optimized execution core 217, 219 (block 401). If no optimized execution cores are available, then execution arbitrator 215 waits until an optimized execution core 217, 219 signals the completion of a trace or checks periodically to determine when an optimized execution core 217, 219 is available. Execution arbitrator 215 determines if both optimized execution cores 217, 219 are available or if only one of the two is available (block 403). If both optimized execution cores 217, 219 are available, execution arbitrator 215 may assign the next trace to either optimized execution core 217, 219 (block 405). After the trace has been assigned execution arbitrator 215 determines availability again if there are traces waiting to be assigned to optimized execution cores 217, 219 for processing (block 401).

In one embodiment, if only one optimized execution core is available then execution arbitrator 215 begins a series of calculations to determine the length of time (e.g., the number of cycles or similar measurement of time) to wait before assigning the next trace to the available optimized execution core (blocks 407-411). This set of calculations determines the period of time necessary for all the data dependencies to be resolved between a currently executing trace and a trace that is about to be executed. In one embodiment, execution arbitrator 215 calculates the maximum ‘difference consumer producer’ (DCP) value between the executing trace and trace to be assigned (block 407). The DCP is the minimal time that a consumer must wait for its producer before it may start executing in order to preserve correct program semantics. In the context of executing instructions and traces a consumer is an instruction that requires data in a register or memory location that is altered by a previous instruction. A producer is the previous instruction that alters or generates the value required by the consumer.

In one embodiment, obtaining the maximum DCP value for two traces involves calculating a set of constituent DCP values. These calculations include calculating a DCP value for each live-in and live-out register within a trace to be executed. A live-in register is a register that contains data to be utilized by an instruction where the value in the register is determined by a preceding instruction. A live-out register is a register to be utilized by an instruction to store a value that will be used by a subsequent instruction. The register DCP calculations include read after write (RAW) DCP calculations and write after read (WAR) DCP calculations. A RAW DCP in this context is the time necessary for the register to be written to by a first earlier executing trace such that the value needed by a second trace is available when it reads the register. A RAW is an instruction that reads a register value after it has been written to by another instruction. A WAR is an instruction that writes to a register after that register has been read from by another instruction. A WAR DCP is the time necessary for the value in a register to read by a first trace before it is subsequently over written by a second trace.

In one embodiment, the RAW DCP values for each register are determined by checking if the register whose value is being determined is in the list of live-in registers of the executing trace or live-out register list of the trace to be assigned. If the register is not in the lists then the DCP value of the register is not a factor in the overall DCP between the two traces. If the register is in the lists then the RAW value DCP for that register is based on the difference between the live-out completion time from the executing trace and the live-in start time for the next trace. Similarly, the WAR DCP value for each register is determined by checking if the register whose value is being determined is in the list live-in registers of the executing trace or the live-out list of the trace to be assigned. If the register is not in the lists then the DCP value of the register is not a factor in the DCP between the traces. If the register is in the lists then the WAR DCP value for that register is based on the difference between the live-in finish time of the executing trace and the start operation time of the register in the trace to be assigned.

In one embodiment, a maximum DCP value is also calculated for memory accesses by each trace. The maximum DCP value calculation includes a RAW memory DCP calculation and a WAR memory DCP calculation. These calculations mirror the calculation for registers. The DCP calculations involving memory measure a time period of maximum or predicted latency for retrieving and storing data in system memory 105. When each of the DCP calculations is made for each memory and register access in each trace the maximum value generated for any individual operation is selected as the overall DCP between the two traces.

In one embodiment, a RAW memory DCP is calculated by retrieving the time of the first memory read operation in the trace to be assigned and the time of the last memory write operation in the trace already executing. Each of these values is stored in the trace data. If values exist for both times then the maximum DCP between the traces for the RAW memory dependencies is the difference between the retrieved last memory write operation time and first memory read time from the respective traces. If a value does not exist for either timing then the DCP value for the RAW memory operations is not relevant to the final DCP between the traces. The WAR memory DCP is calculated by retrieving the time of the first memory write operation in the trace to be assigned and the time of the last memory read of the executing trace. If values exist for both times then the maximum DCP between the traces for the RAW dependencies is the difference between the retrieved first memory write time and the last memory read times of the respective traces.

In one embodiment, the actual length of time remaining to execute the entire preceding trace is calculated (block 409). This value is used to calculate a final wait period for a second trace to be assigned to an available optimized execution core (block 411). The final wait period is an updated DCP value based on selecting the maximum value between the DCP with the actual remaining time of the executing trace subtracted therefrom and zero. This value may be referred to as the parallel delta value. This value adjusts for the possibility that a preceding trace may have already progressed in its processing passed the wait period needed. In this scenario the final wait period or parallel delta is zero.

In one embodiment, once the parallel delta has been determined execution arbitrator 215 waits the period of time corresponding to the parallel delta (e.g., a number of cycles or similar measurement of time) before assigning the next trace to an optimized execution core (block 413). This time period may be zero. After the time period has expired execution arbitrator 215 assigns the next trace to the available optimized execution core 217, 219 (block 415). Execution arbitrator 215 then restarts the process by checking the availability of optimized execution cores 217, 219 if there is a trace present in the VLIW trace queue 213 (block 401).

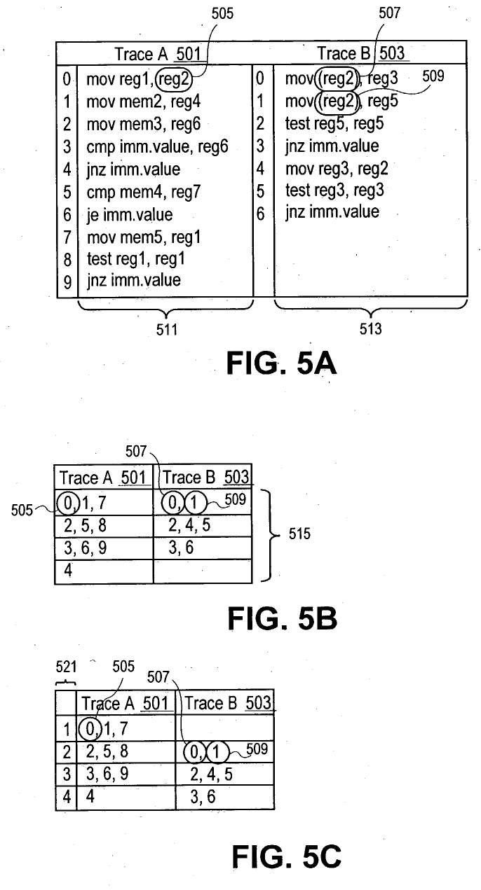

FIGS. 5A-C, illustrate an exemplary set of traces A and B and the parallel execution of these traces. FIG. 5A is a tabular illustration of exemplary trace A 501 having nine instructions 511 and exemplary trace B 503 having six instructions 513. Trace A 501 includes a register live-out 505. Trace B 503 includes register live-ins 507 and 509. In this example, trace A precedes trace B in program order. Live-in registers 507 and 509 depend on live-out register 505. In one exemplary embodiment, VLIW compiler 225 analyzes trace A 501 and trace B 503 and schedules the instructions into VLIWs as illustrated in FIG. 5B. The VLIW scheduling occurs statically while trace A 501 and trace B 503 are stored in trace cache 209. VLIW compiler labels each instruction as belonging to a determined VLIW. When the trace is loaded into the VLIW trace queue 213 by cache arbitrator 211 the instructions are grouped into the appropriate VLIWs. FIG. 5B illustrates the instructions grouped into VLIWs where each row 515 represents a VLIW for each trace. This results in four VLIWs for trace A 501 and three VLIWs for trace B 503.

In the example, execution arbitrator 215 determines that both optimized execution cores are available and loads trace A 501 into a first optimized execution core. Execution arbitrator 215 then, determines the parallel delta between trace A 501 and trace B 503. The parallel delta in this example is one. Execution arbitrator 215 must wait one cycle before assigning trace B 503 to the second optimized execution core. The parallel delta in this example reflects the data dependencies between instruction zero 505 in trace A 501 and instructions zero 507 and one 509 of trace B 503. Instructions zero 507 and one 509 of trace B require that instruction zero 505 of trace A 501 be resolved before they can be properly executed.

FIG. 5C is a tabular illustration of the exemplary execution of trace A 501 and trace B 503. Column 521 indicates the cycle number that each VLIW is executed on relative to the start of trace A 501. Trace B 503 is scheduled to start on cycle two. Instruction zero 505 of trace A 501 has completed by the start of cycle two. Instructions zero 507 and one 509 of trace B 503 can be executed on cycle two. This allows trace A 501 to execute in parallel with trace B 503 without the complex architecture required by out of order processing and scheduling. This simplified architecture also saves energy and space compared with out of order processing architecture.

In one embodiment, the execution arbitrator 215, VLIW compiler 225 and similar components may be implemented in software (e.g., microcode or higher level computer languages). The software implementation may also be used to run simulations or emulations of the components. A software implementation may be stored on a machine readable medium. A “machine readable” medium may include any medium that can store or transfer information. Examples of a machine readable medium include a ROM, a floppy diskette, a CD-ROM, an optical disk, a hard disk, a radio frequency (RF) link, or similar media.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. An apparatus comprising:
a first execution core to process a first set of instructions;
a second execution core to process a second set of instructions;
a first arbitration unit coupled to the first execution core and the second execution core, the first arbitration unit to assign the first set of instructions to the first execution core, the first arbitration unit to determine a time period to delay assignment of the second set of instructions to the second execution core based on data dependencies between the first set of instructions and second set of instructions.

2. The apparatus of claim 1, further comprising:
a second arbitration unit coupled to the first and second execution core to determine the set of instructions to retire based on an alternating pattern between the first execution core and second execution core.

3. The apparatus of claim 1, further comprising:
a VLIW trace queue coupled to the first arbitration unit to store a set of instructions to be processed.

4. The apparatus of claim 3, further comprising:
a trace cache coupled to the VLIW trace queue to store VLIW traces.

5. The apparatus of claim 1, wherein the time period is the length of time necessary to resolve all live-in data of the second set of instructions dependent on the live-out data of the first set of instructions.

6. A method comprising:
assigning a first set of instructions to a first execution core;
calculating a delay period to resolve data dependencies between the first set of instructions and a second set of instructions; and
assigning the second set of instructions to a second execution core after the delay period.

7. The method of claim 6, further comprising:
retiring a third set of instructions from one of the first execution core and second execution core based on an alternating pattern.

8. The method of claim 6, further comprising:
constructing a VLIW from a set of instructions stored in an instruction cache.

9. The method of claim 6, wherein the calculating a delay period includes determining the maximum latency required to resolve live-in register data.

10. The method of claim 6, wherein the calculating a delay period includes determining the maximum latency required to resolve memory access data.

11. An apparatus comprising:
a means for assigning an instruction set to a first means for processing and a second means for processing, the means for assigning to determine a delay period to resolve data dependencies of the instructions set.

12. The apparatus of claim 11, further comprising:
a means for selecting the instruction set to retire the instruction set, the means for selecting alternating between the first means for processing and the second means for processing.

13. The apparatus of claim 11, further comprising:
a means for storing the instruction set; and;
a means for constructing a VLIW from the instruction set.

14. The apparatus of claim 11, wherein the means for assigning to calculate the delay period by determining the maximum number of clock cycles required to resolve one of a read after write operation live-in, a write after read operation live-out, a read after write memory access and a write after read memory access.

15. A machine readable medium, having stored therein a set of instructions, which when executed cause a machine to perform a set of operations comprising:
assigning a first set of instructions to a first execution core;
calculating a time period required to resolve data dependencies for a second set of instructions;
assigning the second set of instructions to a second execution core at the expiration of the time period.

16. The machine readable medium of claim 15, having further instructions stored therein, which when executed cause a machine to perform a set of operations, further comprising:
retiring one of a first set of instructions and a second set of instructions based on an alternating pattern.

17. The machine readable medium of claim 15, wherein the calculating the time period includes determining the maximum time required to resolve a live in register data.

18. The machine readable medium of claim 15, wherein the calculating the time period includes determining the maximum latency required to resolve a memory access.

19. A system comprising:
a system memory to store program instructions;
a communications hub coupled to the system memory to handle access to system memory;
a processing unit coupled to the communications hub, the processing unit to process instructions, the processing unit including a first execution core to process a first set of instructions, a second execution core to process a second set of instructions, an arbitration unit to assign first and second set of instructions to the first and second execution cores, and a third execution core to process a third set of instructions, the first and second set of instructions from a set of frequently used instructions and the third set of instructions from a less frequently used set of instructions, the arbitration unit to determine a delay period to resolve data dependencies between the first set of instructions and second set of instructions.

20. The system of claim 19, further comprising:
a trace cache coupled to the arbitration unit to store the first and second set of instructions;
a VLIW compiler coupled to the trace cache to schedule the first set of instructions into a set of VLIWs.

21. The system of claim 19, wherein the central processing unit further includes a retirement arbitrator to select an execution core from which to retire processed data.
